(19) United States
(12) Patent Application Publication
(10) Pub. No.: US 2005/0060279 A1
(43) Pub. Date: Mar. 17, 2005

(54) Method of and system for file transfer

(75) Inventor: Xin Xue, San Jose, CA (US)

Correspondence Address: HAVERSTOCK & OWENS LLP, 162 NORTH WOLFE ROAD, SUNNYVALE, CA, 94086, US

(73) Assignees: SONY CORPORATION; SONY ELECTRONICS INC.

(21) Appl. No.: 10/665,698

(22) Filed: Sep. 17, 2003

(51) Int. Cl. G06F 7/00

(52) U.S. Cl. 707/1

(57) ABSTRACT

The present invention includes a method and system for transferring files between a personal computer (PC) and a personal digital assistant (PDA). In the absence of the file stream manager of the PDA being available to the conduit, the present invention defines a mechanism to effectuate file conversion and transfer through the conduit without the file stream manager. The present invention includes a method and system that generates a file in the PC and allocates a record size such that the file is read and written into separate data records of the allocated size before transfer to the PDA. An application information block is generated to identify the number of records and the size of each record. Upon receiving the records in the PDA, the method and system of the present invention utilizes the database manager to read and the file stream manager to write each record into a storage heap before the file and the file stream manager are closed.

### FIELD OF THE INVENTION

The present invention relates to the field of file transfers. More particularly, the present invention relates to the field of transferring files between a personal computer and a personal digital assistant.

### BACKGROUND OF THE INVENTION

The proliferation of personal digital assistants (PDAs) places a new importance on transferring a large number of files to and from a personal computer (PC). Currently, the file systems in PDAs are quite different than that of PCs. The PDA does not have a hard disk and all data is stored in random access memory (RAM) on the PDA. On the PDA there are two sections of memory: dynamic memory and storage heap memory. The storage memory holds a database, which is a related collection of records or chunks of data. In this storage heap memory, the size of a record or chunk of memory cannot exceed 64 KB. For data generated on the PDA, a database manager manages the storage of data stored on the storage memory utilizing an application information block or a file stream manager which provides a file based application programming interface (API). The application information block is used to store data-base wide information.

When files are being transferred from a PC to the PDA, the file stream manager in the PDA is not available to the hotsync conduit from the PC to the PDA. Accordingly, current file transfers between PCs and PDAs are unable to effectively transfer very large files, typically those files that are larger than 64 KB. Furthermore, current file transfers between PCs and PDAs do not have a file stream manager available to the conduit as explained above.

### SUMMARY OF THE INVENTION

The present invention includes a method and system for transferring files between a personal computer (PC) and a personal digital assistant (PDA). In the absence of the file stream manager of the PDA being available to the conduit, the present invention defines a mechanism to effectuate file conversion and transfer through the conduit without the file stream manager. The present invention includes a method and system that generates a file in the PC and allocates a record size such that the file is read and written into separate data records of the allocated size before transfer to the PDA. An application information block is generated to identify the number of records and the size of each record. Upon receiving the records in the PDA, the method and system of the present invention utilizes the database manager and the file stream manager to read and write each record into a storage heap before the file and the file stream manager are closed.

In one aspect of the present invention, a method of transferring an application file from a personal computer to a personal digital assistant through a conduit comprises generating a file corresponding to the application file, reading a portion of the file into a record, wherein the record is a predetermined size, copying the data to a record buffer and transmitting the records in the record buffer to the personal digital assistant, wherein reading a portion of the file into a record is repeated until all of the files are read into a set of records. An application information block is transmitted with the contents of the record buffer. The method further comprises allocating the predetermined record size and calculating the number of records prior to reading a portion of the file into a record. The predetermined record size is preferably less than 64 KB. The application information block includes size of the records being transmitted and number of the records being transmitted. When the contents of the record buffer are received in the personal digital assistant, the method further comprises reading the application information block, opening the records, reading each of the records of the database, writing each of the records of the database to a storage heap and closing the database.

In another aspect of the present invention, a system for transferring an application file from a personal computer to a personal digital assistant via a conduit comprises means for generating a file corresponding to the application file, a first means for reading a portion of the file into a record, wherein the record is a predetermined size, means for copying the record to a record buffer and means for transmitting the records in the record buffer to the personal digital assistant, wherein the first means for reading operates until all of the file is read into a set of records. An application information block is transmitted with the contents of the record buffer. The system further comprises means for allocating the predetermined record size and calculating the number of records. The predetermined record size is preferably less than 64 KB. The application information block includes size of the records being transmitted and number of the records being transmitted. When the contents of the record buffer are received in the personal digital assistant, the system further comprises a second means for reading the application information block, means for opening the records with a database manager, a third means for reading each of the records of the file with the database manager, means for writing each of the records of the file to a storage heap and means for closing the file and the file stream manager.

In still another aspect of the present invention, a system for transferring an applicatoin file via a conduit comprises a personal computer configured to generate a file corresponding to the application file, wherein a portion of the file is read into a record, wherein the record is a predetermined size, and further wherein the file is read until all of the file is read into a set of records, a record buffer configured to receive the set of records, where the personal computer is configured to transmit contents of the record buffer to a personal digital assistant. An application information block is transmitted with the contents of the record buffer. The predetermined record size is allocated and the number of records is calculated prior to reading the file into the set of records. The predetermined record size is preferably less than 64 KB. The application information block includes size of the records being transmitted and number of the records being transmitted. The contents of the record buffer are received in a personal digital assistant, the system further comprising a database manager configured to read the application information block, and further configured to open each of the set of records and a storage heap configured to receive each of the set of records wherein each of the set of records is written to the file heap by the file stream manager, and further wherein the file and the file stream manager are closed after the set of records are written to the storage heap.

In yet another aspect of the present invention, a method of transferring an application file from a personal computer to a personal digital assistant via a conduit comprises generating a file corresponding to the application file, reading a portion of the file into a record, wherein the record is a predetermined size, copying the record to a record buffer, transmitting the contents of the record buffer to the personal digital assistant, wherein reading a portion of the file into a record is repeated until all of the file is read into a set of records, and further wherein an application information block is transmitted with the contents of the record buffer, receiving the contents of the record buffer in the personal digital assistant, reading the application information block, opening the records with a database manager, reading each of the records of the file with the database manager, writing each of the records of the database to a storage heap and closing the file and the file stream manager. The method further comprises allocating the predetermined record size and calculating the number of records prior to the reading a portion of the file into a record. The predetermined record size is preferably less than 64 KB. The application information block includes size of the records being transmitted and number of the records being transmitted.

In another aspect of the present invention, a system for transferring an application file via a conduit comprises a personal computer configured to generate a file corresponding to the application file, wherein a portion of the file is read into a record, wherein the record is a predetermined size, and further wherein the file is read until all of the file is read into a set of records, a record buffer configured to receive the set of records, where the personal computer is configured to transmit contents of the record buffer through a conduit, and further wherein an application information block is transmitted with the contents of the record buffer and a personal digital assistant configured to receive the contents of the second buffer, the personal digital assistant including a database manager configured to read the application information block, and further configured to open each of the set of records and a storage heap configured to receive each of the set of records wherein each of the set of records is written to the file heap by the file stream manager, and further wherein the file and the file stream manager are closed after the set of records are written to the storage heap. The predetermined record size is allocated and the number of records is calculated prior to reading the file into the set of records. The predetermined record size is preferably less than 64 KB. The application information block includes size of the records being transmitted and number of the records being transmitted.

### BRIEF DESCRIPTION OF THE DRAWINGS

FIG. 1 illustrates an exemplary graphical representation of a PC/PDA system.

FIG. 2 illustrates an exemplary block diagram of a storage heap according to the present invention.

FIG. 3 illustrates a block diagram of an exemplary file transfer system according to the present invention.

FIG. 4 illustrates a method of file transfer according to the present invention.

### DETAILED DESCRIPTION OF THE EMBODIMENTS

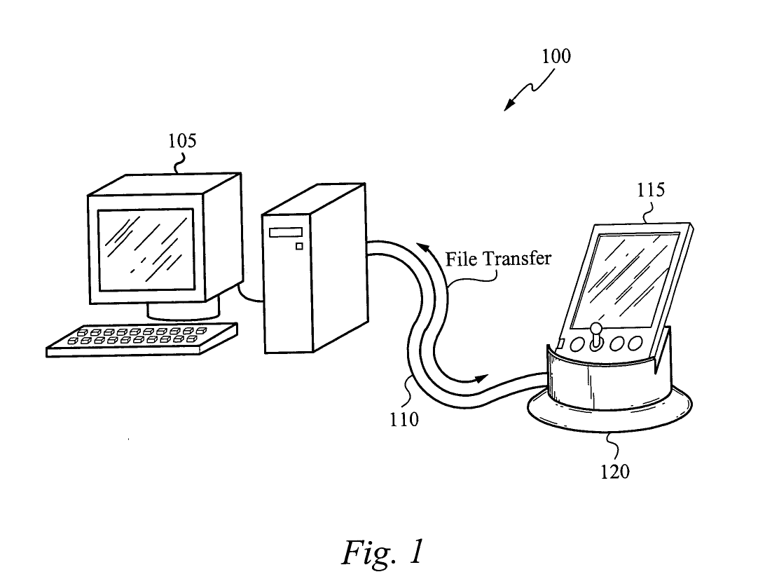

Embodiments of the present invention include a method and system of transferring files from a personal computer (PC) to a personal digital assistant (PDA). FIG. 1 depicts an exemplary file transfer system 100 of the preferred embodiment of the present invention. In FIG. 1, a PDA 115 in a hotsync cradle 120, is coupled to a PC 105 by a conduit 110. In current systems such as that depicted in FIG. 1, when data files from the PC 105 are transferred to the PDA 115 through the conduit 110, a file stream manager in the PDA 115, which ordinarily provides a file-based application programming interface (API) on the PDA 115, is not available to the conduit 110 for file transfer. The file transfer system 100 of the preferred embodiment of the present invention includes a system and method that allow for this file conversion to occur through the conduit 110, without the need for the API.

Still referring to FIG. 1, the file transfer system 100 includes a PC 105 and a PDA 115. The file systems for the PC 105 and the PDA 115 are quite different in that the PC 105 includes a hard disk for the storage of large files while the PDA 115 does not have such a memory system, but rather stores application data in a random access memory (RAM). The RAM of the PDA 115 is divided into a dynamic storage and a storage heap. The storage heap is configured much like the hard disk of the PC 105 in that the storage heap can hold a file that is essentially a related collection of records or chunks. Such a file also includes an application information block that can be used to store information about the database.

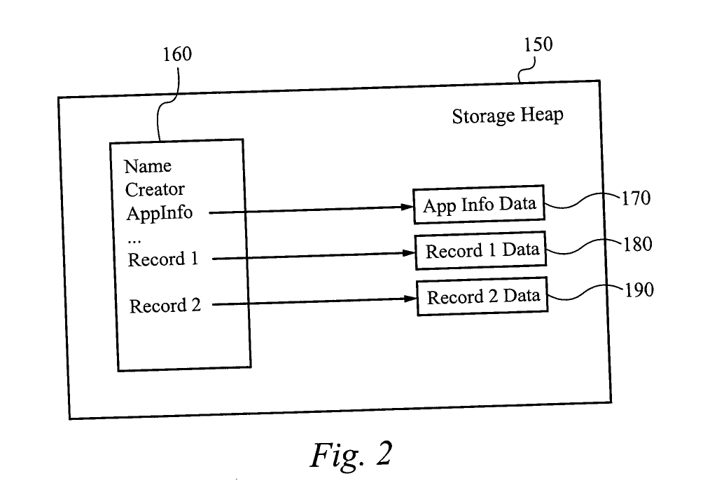

FIG. 2 illustrates an exemplary block diagram of a storage heap 150 of the present invention, depicting how a file 160 is stored as a number of records 170, 180, 190 in the storage heap 150. Here, the file 160 includes file information such as the name of the file 160, the creator of the file 160, as well as any application information to be saved, as well as application data records (record 1, record 2, etc). This file 160 is stored in the storage heap 150 as an application information block 170 and a number of records 180, 190 corresponding to the application data in the file 160. The name of the file, creator information and the application information are stored in the application information data block 170. The data records are stored in the records 180 and 190. The application information block 170 and records 180, 190 in this format are recognizable to a file stream manager of the PDA 115, and therefore the database manager APIs for the PDA 115 are available to the conduit 110 for data being transferred through the conduit 110 in this format.

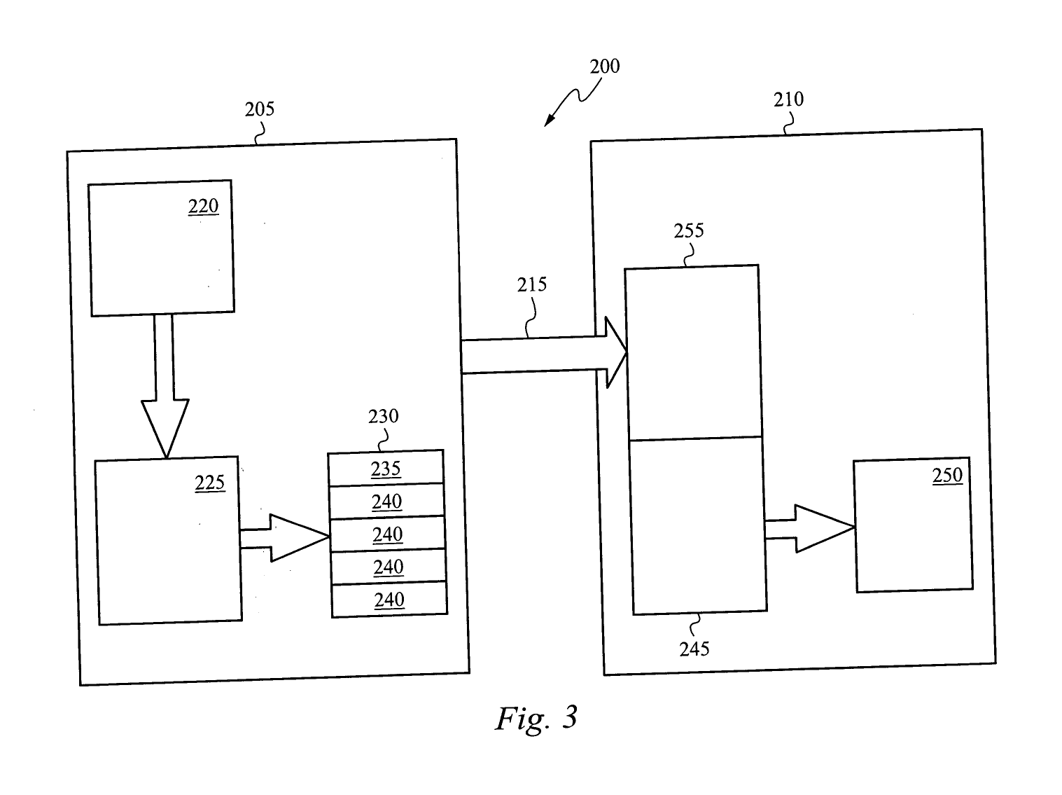

FIG. 3 depicts a block diagram of an exemplary file transfer system 200 according to the present invention. In FIG. 3, the PC 205 includes a hard disk 220 where application files are stored. When an application file is to be transferred to the PDA 210, a file 225 is generated. The file 225 corresponds to the application file to be transferred and likewise bears the same name as the application file to be transferred. The content data of the file 225 is then read up to a predetermined record size. The predetermined record size is determined by the memory constraints of the PDA 210. Typically, in order to be recognized by the database manager 255, a record 240 cannot be bigger than 64 KB in size. Prior to reading the file 225, the number of records 240 needed to store the data within the entire file 225 is calculated. Preferably, the file 225 is read 60 KB at a time, and each 60 KB portion is saved as a record 240 in the record buffer 230. For example, a 450 KB file 225 being read 60 KB at a time and saved as records 240 in the record buffer 230 would result in seven 60 KB records 240 and one 30 KB record 240.

Still referring to FIG. 3, after the file 225 has been read and written into the record buffer 230 as a number of records 240, an application information block 235 is generated and stored in the record buffer 230 as well. The application information block 230 includes the specifics of the file 225 and the resulting set of records 240 in the record buffer 230 including, but not limited to the file name, creation date, number of records, size of each or last record and the creator of the file. Of course, more or less specifics can be added or deleted from the application information block 235 as required by the user or the file transfer system 200. The record buffer 230 then transfers the application information block 235 and the records 240 through the conduit 215 to the PDA 210, in any appropriate manner as known to those skilled in the art.

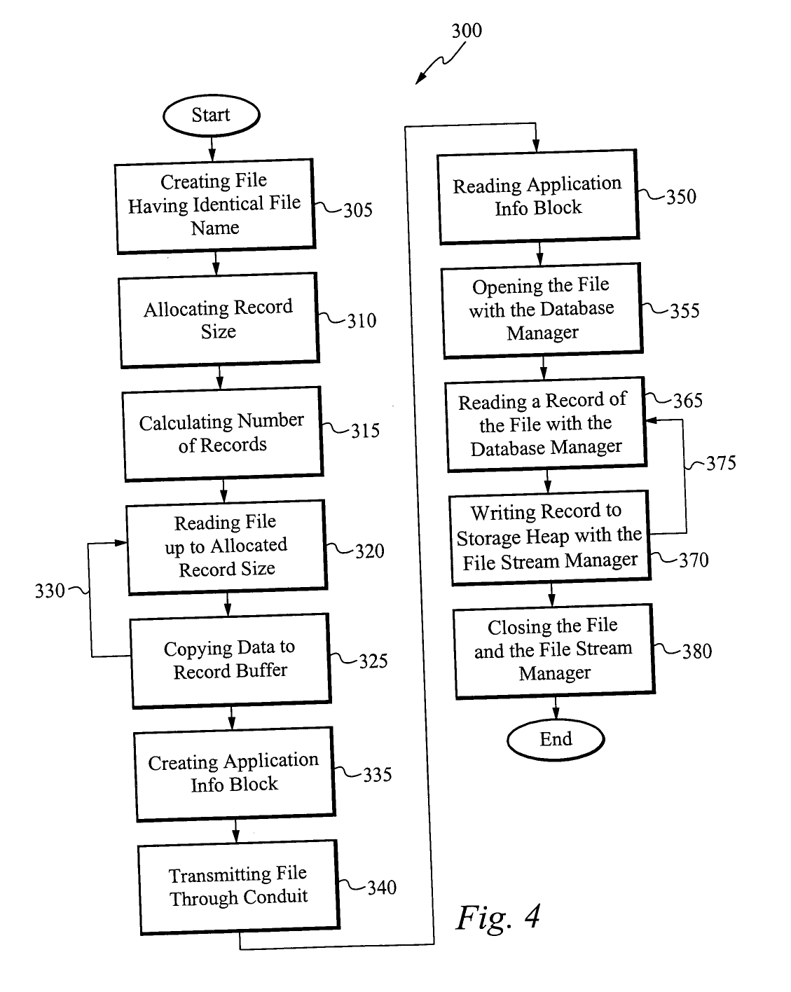

Still referring to FIG. 3, the database manager 255 opens the application information block 235 and reads the application information block 235 for the number of records 240 as well as the size of the last block. By knowing the size of the last record 240 of the file 225, the database manager 255 knows when all of the records 240 have been received, and thus, when the entire file 225 has been received. Upon receiving the entire file 225, the file stream manager 245 writes each record 240 to the storage heap 250 to reconstruct the file 225. The file 225 and file stream manager 245 are then closed. Contents of the storage heap 250 in the PDA 210 can also be transferred to the hard disk 220 in the PC 205 by simply reversing the procedure described above and the method described in FIG. 4 below.

A method of transferring a file from a PC to a PDA of the preferred embodiment of the present invention is depicted in FIG. 4. The file transfer 300 starts at the step 305, when a file is generated in the PC having an identical name as the application file that is to be transferred from the PC to the PDA. The file generated at the step 305 directly corresponds to the application file to be transferred. After the file is generated, a record size is allocated such that the record size does not exceed the system constraints of the PDA. Current PDA systems limit the record size to 64 KB. Therefore, the record size should not exceed 64 KB and any file larger than 64 KB should be divided into a number of records. Preferably, a 60 KB record size will be allocated. Alternatively, any appropriate record size corresponding to the system constraints of the target PDA is allocated.

At the step 315, the total number of records to be written is calculated by dividing the size of the file by the allocated record size. If there is a remainder due to this division, an additional record is needed. For example, a 450 KB file requires 8 records in a system where a 60 KB record size is allocated as there will be seven 60 KB records and one 30 KB record, equaling 450 KB size of the file.

Still referring to FIG. 4, the file is read up to the allocated record size, and at the step 325, that portion of the file is copied to a record buffer. The path 330 repeats the reading and copying steps of the step 320 and the step 325 until the entire file is copied into the record buffer as the appropriate number of records. Revisiting the example above, the path 330 will be utilized seven times so that all eight records of the 450 KB file are read and copied into the record buffer.

Referring back to FIG. 4, after the entire file is copied into records in the record buffer at the step 325, an application information block is generated at the step 335. The application information block includes data such as the name of the file, the number of records in the file and the size of the records, specifically the size of the last record. The contents of the application information block may be tailored as desired by the user or due to additional system constraints. At the step 340, the contents of the record buffer, including the application information block are transmitted through the conduit to the PDA.

The application information block is then read in the PDA by the database manager at the step 350. With the information in the application information block, the database manager is then able to open the file at the step 355. Once the file is opened, the database manager reads the first record of the file at the step 365. Once the first record is opened at the step 365, the record is then written to the storage heap at the step 370 with the file stream manager. Again, as described in path 330, the record reading and writing at the steps 365 and 370 are repeated through the path 375 until the last record is written into the storage heap at the step 370. After all of the records are stored in the storage heap at the step 370, the file and the file stream manager are closed at the step 380. It should be noted that this method can be reversed for transferring files from the PDA to the PC.

In operation, a user will allocate a file to be transferred from the PC to the PDA. If the size of that file exceeds the maximum record size of records within the storage heap memory of the PDA, the file transfer system of the present invention will divide the file size into a number of records, at the PC. Each of the records are stored in a transfer buffer and are all of a size less than the maximum record size of the records within the storage heap memory of the PDA. An application information block is also included in the transfer buffer. The application information block includes information about the file content as well as the size and number of records included. The application information block and records are then transferred to the PDA, preferably through a hot sync operation, when the PDA is available. When received by the PDA, the application information block and records are stored in the storage heap memory for use on the PDA.

As described herein, the file transfer system of the present invention allows large files, exceeding the maximum record size of storage heap memory of the PDA, to be transferred to the PDA. The files are broken up into a number of records, each smaller than the maximum record size and transferred to the PDA. The records are then stored in the storage heap memory and available for use on the PDA.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. Specifically, it will be apparent to one of ordinary skill in the art that while the preferred embodiment of the present invention is used with PCs and PDAs, the present invention can also be implemented on any other appropriate file transfer system.

1. A method of transferring an application file from a personal computer to a personal digital assistant through a conduit, the method comprising:
a. generating a file corresponding to the application file;
b. reading a portion of the file into a record, wherein the record is a predetermined size;
c. copying the record to a record buffer; and
d. transmitting the records in the record buffer to the personal digital assistant,
wherein reading a portion of the file into a record is repeated until all of the file is read into a set of records.

2. The method according to claim 1 wherein an application information block is transmitted with the contents of the record buffer.

3. The method according to claim 1 further comprising allocating the predetermined record size and calculating the number of records prior to reading a portion of the file into a record.

4. The method according to claim 3 wherein the predetermined record size is less than 64 KB.

5. The method according to claim 2 wherein the application information block includes:
a. size of the records being transmitted; and
b. number of the records being transmitted.

6. The method according to claim 1 wherein when the contents of the record buffer are received in the personal digital assistant, the method further comprising:
a. reading the application information block;
b. opening the records;
c. reading each of the records of the database;
d. writing each of the records of the database to a storage heap; and
e. closing the file.

7. A system for transferring an application file from a personal computer to a personal digital assistant via a conduit, the system comprising:
a. means for generating a file corresponding to the application file;
b. a first means for reading a portion of the file into a record, wherein the record is a predetermined size;
c. means for copying the record to a record buffer; and
d. means for transmitting the records in the record buffer to the personal digital assistant,
wherein the first means for reading operates until all of the file is read into a set of records.

8. The system according to claim 7 wherein an application information block is transmitted with the contents of the record buffer.

9. The system according to claim 7 further comprising means for allocating the predetermined record size and calculating the number of records.

10. The system according to claim 9 wherein the predetermined record size is less than 64 KB.

11. The system according to claim 8 wherein the application information block includes:
a. size of the records being transmitted; and
b. number of the records being transmitted.

12. The system according to claim 7 wherein when the contents of the record buffer are received in the personal digital assistant, the system further comprises:
a. a second means for reading the application information block;
b. means for opening the records with a database manager;
c. a third means for reading each of the records of the file with the database manager;
d. means for writing each of the records of the file to a storage heap with a file stream manager; and
e. means for closing the file and the file stream manager.

13. A system for transferring an application file via a conduit, the system comprising:
a. a personal computer configured to generate a file corresponding to the application file, wherein a portion of the file is read into a record, wherein the record is a predetermined size, and further wherein the file is read until all of the file is read into a set of records; and
b. a record buffer configured to receive the set of records, where the personal computer is configured to transmit contents of the record buffer to a personal digital assistant.

14. The system according to claim 13 wherein an application information block is transmitted with the contents of the record buffer.

15. The system according to claim 13 wherein the predetermined record size is allocated and the number of records is calculated prior to reading the file into the set of records.

16. The system according to claim 13 wherein the predetermined record size is less than 64 KB.

17. The system according to claim 14 wherein the application information block includes:
a. size of the records being transmitted; and
b. number of the records being transmitted.

18. The system according to claim 13 wherein the contents of the record buffer are received in a personal digital assistant, the system further comprising:
a. a database manager configured to read the application information block, and further configured to open each of the set of records; and
b. a storage heap configured to receive each of the set of records wherein each of the set of records is written to the file heap by a file stream manager,
further wherein the file and the file stream manager are closed after the set of records are written to the storage heap.

19. A method of transferring an application file from a personal computer to a personal digital assistant via a conduit, the method comprising:
a. generating a file corresponding to the application file;
b. reading a portion of the file into a record, wherein the record is a predetermined size;
c. copying the record to a record buffer;
d. transmitting the contents of the record buffer to the personal digital assistant, wherein reading a portion of the file into a record is repeated until all of the file is read into a set of records, and further wherein an application information block is transmitted with the contents of the record buffer;
e. receiving the contents of the record buffer in the personal digital assistant;
f. reading the application information block;
g. opening the records with a database manager;
h. reading each of the records of the file with the database manager;
j. writing each of the records of the file to a storage heap with a file stream manager;
and
k. closing the file and the file stream manager.

20. The method according to claim 19 further comprising allocating the predetermined record size and calculating the number of records prior to the reading a portion of the file into a record.

21. The method according to claim 20 wherein the predetermined record size is less than 64 KB.

22. The method according to claim 19 wherein the application information block includes:
a. size of the records being transmitted; and
b. number of the records being transmitted.

23. A system for transferring an application file via a conduit, the system comprising:
a. a personal computer configured to generate a file corresponding to the application file, wherein a portion of the file is read into a record, wherein the record is a predetermined size, and further wherein the file is read until all of the file is read into a set of records;
b. a record buffer configured to receive the set of records, where the personal computer is configured to transmit contents of the record buffer through a conduit, and further wherein an application information block is transmitted with the contents of the record buffer; and
c. a personal digital assistant configured to receive the contents of the second buffer, the personal digital assistant including:
i. a database manager configured to read the application information block, and further configured to open each of the set of records; and
ii. a storage heap configured to receive each of the set of records wherein each of the set of records is written to the file heap by a file stream manager, and further wherein the file and the file stream manager are closed after the set of records are written to the storage heap.

24. The system according to claim 23 wherein the predetermined record size is allocated and the number of records is calculated prior to reading the file into the set of records.

25. The system according to claim 24 wherein the predetermined record size is less than 64 KB.

26. The system according to claim 23 wherein the application information block includes:
a. size of the records being transmitted; and
b. number of the records being transmitted.
